(19) United States
(12) Patent Application Publication
(10) Pub. No.: US 2017/0071151 A1
(43) Pub. Date: Mar. 16, 2017

(54) Deer feeding article and method of use

(71) Applicant: Daniel Vernon Quinn, Sault Ste. Marie, MI (US)

(72) Inventor: Daniel Vernon Quinn, Sault Ste. Marie, MI (US)

(21) Appl. No.: 14/999,968

(22) Filed: Jul. 20, 2016

Related U.S. Application Data
(60) Provisional application No. 62/283,764, filed on Sep. 10, 2015.

(51) Int. Cl. A01K 5/00; A23K 50/00; A01M 31/00; A23K 40/20; A23K 10/40; A23K 10/33; A23K 10/30; A23K 10/00; A01K 5/015

(52) U.S. Cl. CPC A01K 5/00; A23K 10/00; A23K 50/00; A01M 31/00; A01K 5/015; A23K 10/40; A23K 10/33; A23K 10/30; A23K 40/20

(57) ABSTRACT

An article of manufacture for attracting and feeding deer. The article is in the shape of a bar of deer feed formed around a cord. The cord is of a length sufficient to extend from the bar so that the bar can be suspended from the cord in use. The bar is sufficiently thin that a deer is able to bite the bar. The bar can be hung from a tree branch or the like but preferably a plurality of bars are hung in an array on a tree.

The present invention relates to articles of manufacture for attracting wildlife and more particularly to articles shaped and arrayed to facilitate the attraction of deer to a hunting location. The instant application claims priority to U.S. Provisional Patent Application Ser. No. 62/283,764 filed Sep. 10, 2015. While various blocks have been proposed as wildlife and animal feed devices as for example described in the following U.S. patents (incorporated herein by reference): Lush et al., U.S. Pat. No. 5,855,943, issued Jan. 5, 1999; Weil, U.S. Pat. No. 1,009,361, issued Nov. 21, 1911; Aniser, U.S. Pat. No. 2,908,250, issued Oct. 13, 1959; Patten, U.S. Pat. No. 2,139,910, issued Dec. 13, 1938; Molitorisz, U.S. Pat. No. 3,357,835, issued Dec. 12, 1967; Mendes et al., U.S. Pat. No. D528,261, issued Sep. 19, 2006; Mendes et al., U.S. Pat. No. D538,506, issued Mar. 20, 2007; Unlu et al., U.S. Pat. No. D516,276, issued Mar. 7, 2006; Turner, U.S. Pat. No. D501,700, issued Feb. 15, 2005; Englisch, U.S. Pat. No. D512,810, issued Dec. 20, 2005; Bazzaro et al., U.S. Pat. No. 6,344,224, issued Feb. 5, 2002; and Schneider, U.S. Pat. No. 5,052,342, issued Oct. 1, 1991. None of such devices are perfectly suitable for attracting and feeding deer. As pointed out in US Patent Application Publication US 2012/0174867 (incorporated herein by reference), deer snouts are designed for biting and severing grasses and leaves, rather than blocks of the shape which had been previously proposed. The feeding block of the '867 publication was in the shape of a grooved cylinder having a hole therethrough along the longitudinal axis of the cylinder, which hole facilitated positioning the cylinder on a stick, arrow or tree branch or the passage of a cord or the like through the hole to hang the cylinder from the branch of a tree or the like. However none of the articles of the prior art achieve the advantages offered by the article and methods of the instant invention.

### BACKGROUND

### Brief Summary of the Invention

The present invention is an important discovery in the art of attracting deer to a hunting location. The instant invention will save time and money for the hunter and will significantly reduce human odor at the hunting location. In one embodiment, the instant invention is an article of manufacture for attracting deer to a hunting location, the article comprising a bar of deer feed formed around a cord, the cord being of a length sufficient to extend from the bar so that the bar can be suspended from the cord to attract deer to a hunting location, the thickness of the bar being sufficiently thin to enable a deer to bite the bar.

In another embodiment, the instant invention is a kit of parts for attracting deer to a hunting location, comprising: (a) a plurality of the articles of manufacture of the instant invention; and (b) an elastic rope so that the bars of the articles of manufacture of the instant invention can be suspended from the elastic rope, the elastic rope surrounding a tree or post.

In yet another embodiment, the instant invention is a method of attracting deer to a hunting location, comprising the step of suspending a plurality of the bars of the instant invention from the cords thereof at a deer hunting location.

### BRIEF DESCRIPTION OF THE DRAWINGS

FIG. 1 is a drawing of a highly preferred article of manufacture of the instant invention

FIG. 2 is a drawing of a highly preferred kit of parts of the instant invention; and

FIG. 3 shows a highly preferred use of the kit of parts shown in FIG. 2.

### DETAILED DESCRIPTION OF THE INVENTION

It is understood that the terminology used herein is for the purpose of describing particular embodiments only and is not intended to be limiting. As used in this specification, the singular forms “a”, “an”, and “the” include plural referents unless the content clearly indicates otherwise. The following terms in the Glossary as used in this application are to be defined as stated below and for these terms, the singular includes the plural.

Various headings are present to aid the reader, but are not the exclusive location of all aspects of that referenced subject matter and are not to be construed as limiting the location of such discussion.

Also, certain US patents and published applications have been incorporated by reference. However, the text of such patents is only incorporated by reference to the extent that no conflict exists between such text and other statements set forth herein. In the event of such conflict, then any such conflicting text in such incorporated by reference US patent or published application is specifically not so incorporated in this application.

### GLOSSARY

in(s). means inch(es)

lb. means pounds

min(s). means minute(s)

the term “cord” encompasses string, twine, cord, line, wire, rope and the like.

The need to feed deer for hunting to have them stop at a feed location with a clear shot requires that the feed both attract the deer and be located where hunting is possible. The deer feed must be cost effective and able to be easily placed where desired.

In a highly preferred embodiment the instant invention comprises bars that are sealed for freshness and conveniently fit into a hunter's back pack for transport to a desired hunting location. In another highly preferred embodiment, the instant invention is a kit of parts that includes such bars. The bars of the instant invention are more portable than conventional deer feed blocks. The bars of the instant invention are more convenient and effective than deer feed dispensers which dispensers require hauling bags of bait and checking the fill level of the dispenser. The bars of the instant invention allow the hunter to strategically place his or her bait along game trails at a distance the hunter has already ranged for an accurate shot.

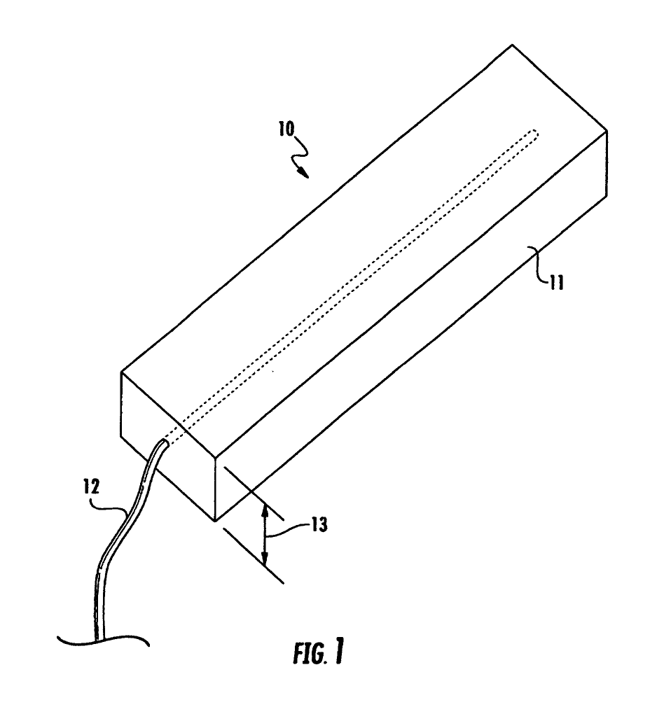

Referring now to FIG. 1, therein is shown a preferred embodiment the instant invention in the form of an article of manufacture 10 for attracting deer comprising a bar 11 of deer feed formed around cord 12, cord 12 being of a length sufficient to extend from bar 11 so that bar 11 can be suspended from cord 12 in use. The other end of the cord 12 can terminate within the bar 11 or also extend from the bar 11 to facilitate a knot or the like to prevent the bar sliding off of the cord 12. The thickness 13 of the bar 11 is sufficiently thin to enable a deer to bite the bar 11. Preferably, the thickness 13 bar 11 is thicker than about one half inch but less than three inches. Most preferably, the thickness of the bar 11 is in the range of from about one inch to about two inches. The cord 12 most preferably has a diameter of from 1/16 inch to ⅛ inch. The cord 12 can be made of natural or synthetic material such as and without limitation thereto, cotton, jute, polyester or polypropylene. The bar 11 can be suspended on the cord 12 from any convenient object such as a tree, a tree branch, a post or a stake.

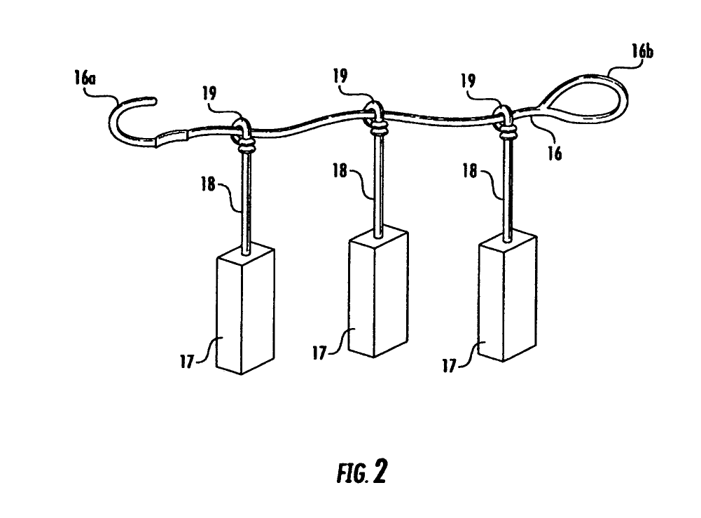

Referring now to FIG. 2, therein is shown a highly preferred kit of parts of the instant invention, which kit includes an elastic rope 16 (often called a bungee cord) having hook 16a at one end thereof and loop 16b at the other end. Articles of the instant invention in the form of bars 17 and cords 18 are shown attached to elastic rope 16 by slip knots 19 in cord 18.

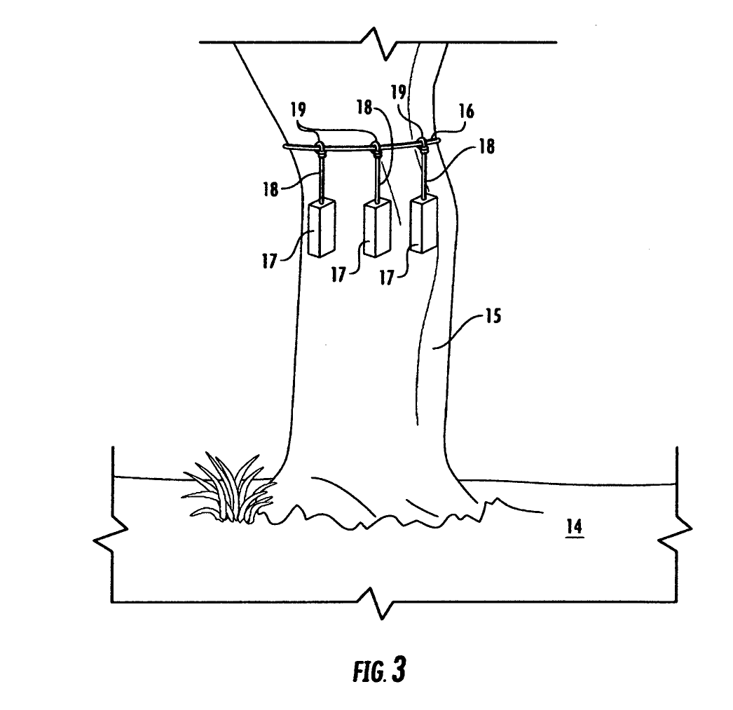

Referring now to FIG. 3, therein is shown a highly preferred method of use of the kit of parts shown in FIG. 2 wherein tree 15 has been surrounded by elastic rope 16. The height of the elastic rope 16 from ground 14 can be increased during non-hunting hours to position the bars 17 at a height too high for deer to reach and lowered during hunting hours to encourage deer to approach the bars 17 during hunting hours. Although an elastic rope is preferred from which to hang one or more of the bars of the instant invention, it should be understood that the bars of the instant invention can be hung from other horizontal supports such as, and without limitation thereto, a rope or cord tied around the trunk of a tree or post or the like.

The deer feed bars of the instant invention can comprise a variety of feed types held together by a binder to form the bar. There are many recipes in the prior art for forming deer feed blocks and most if not all of them can be used to form the bars of the instant invention. The feed types can comprise salt, root vegetables, fruit, grain, nuts and formulated feed pellets. The binder is usually based on a sugar syrup such as corn syrup or molasses, but some recipes use peanut butter at the binder.

### Example

A highly preferred deer feed composition suitable for forming the bars of the instant invention can be made from the following recipe:

2 large sugar beets cut into strips
12 apples—peeled and cut into strips
1-2 lb. bag of carrots cut up.
The above ingredients are dehydrated and then thoroughly mixed with the following ingredients:
6 cups of cracked or whole kernel corn
2 cups of oats
½ cup of flour
½ cup of salt
2 cups of molasses
2 cups crushed acorns
and any desired minerals and supplements.

A portion of the mixture is then placed into a 12 in. by 9 in. pan to form a ½ in. thick layer of the mixture in the pan. Four lengths of 1/16 inch diameter nylon cord are placed over the top of the mixture at 3 in. intervals and then more mixture is added over the cords to form a 1 in. thick layer of the mixture in the pan. The pan is then placed in an oven and baked at 250° F. for 17 min. The pan is cooled and then bars are cut about 1 in. thick by 3 in. wide by 9 in. long making 4 bars per pan with about 12 in of cord extending from each bar.

Although the instant invention has been described with reference to its preferred embodiments, those of ordinary skill in the art may, upon reading and understanding this disclosure, appreciate changes and modifications which may be made which do not depart from the scope and spirit of the instant invention as described above.

What is claimed is:

1. An article of manufacture for attracting deer to a hunting location, the article comprising a bar of deer feed formed around a cord, the cord being of a length sufficient to extend from the bar so that the bar can be suspended from the cord to attract deer to a hunting location, the thickness of the bar being sufficiently thin to enable a deer to bite the bar.

2. The article of claim 1, wherein the thickness of the bar is in the range of from one half inch to three inches.

3. The article of claim 1, wherein the thickness of the bar is in the range of from one to two inches.

4. A kit of parts for attracting deer to a hunting location, comprising: (a) a plurality of the articles of manufacture of claim 1; and (b) an elastic rope so that the bars of the articles of manufacture of claim 1 can be suspended from the elastic rope, the elastic rope surrounding a tree or post.

5. The kit of parts of claim 4, wherein the thickness of each bar is in the range of from one half inch to three inches.

6. The kit of parts of claim 4, wherein the thickness of each bar is in the range of from one to two inches.

7. A method of attracting deer to a hunting location, comprising the step of suspending a plurality of the bars claim 1 from the cords thereof at a deer hunting location.

8. The method of claim 7, wherein the thickness of the bar is in the range of from one half inch to three inches.

9. The method of claim 7, wherein the thickness of the bar is in the range of from one inch to two inches.

10. The method of claim 7, wherein the cords of the plurality of bars are attached to a horizontally positioned support.

11. The method of claim 10, wherein the thickness of the bar is in the range of from one half inch to three inches.

12. The method of claim 10, wherein the thickness of the bar is in the range of from one inch to two inches.

13. The method of claim 10, further comprising the step of locating the horizontally positioned support at a height so that the suspended bars are at a height above the base of the tree or post higher than a deer can reach so that a deer hunter can leave the suspended bars unattended by the hunter during hours when hunting deer is not permitted.

14. The method of claim 11, further comprising the step of locating the horizontally positioned support at a height so that the suspended bars are at a height above the base of the tree or post higher than a deer can reach so that a deer hunter can leave the suspended bars unattended by the hunter during hours when hunting deer is not permitted.

15. The method of claim 12, further comprising the step of locating the horizontally positioned support at a height so that the suspended bars are at a height above the base of the tree or post higher than a deer can reach so that a deer hunter can leave the suspended bars unattended by the hunter during hours when hunting deer is not permitted.
